(19) United States
(12) Patent Application Publication
(10) Pub. No.: US 2025/0036707 A1
(43) Pub. Date: Jan. 30, 2025

(54) CONTENT PROCESSING METHOD AND APPARATUS, DEVICE, AND STORAGE MEDIUM

(71) Applicant: Beijing Zitiao Network Technology Co., Ltd., Beijing (CN)

(72) Inventors: Man LIU, Beijing (CN); Cheng LV, Beijing (CN); Rendan PAN, Beijing (CN); Xinji ZHONG, Beijing (CN)

(21) Appl. No.: 18/771,988

(22) Filed: Jul. 12, 2024

(30) Foreign Application Priority Data
Jul. 24, 2023 (CN) 202310912603.8

(51) Int. Cl. G06F 16/957; G06F 3/0481; G06F 3/0484; G06F 16/9538

(52) U.S. Cl. CPC G06F 16/9577; G06F 3/0481; G06F 3/0484; G06F 16/9538

(57) ABSTRACT

The disclosure relates to a content processing method and apparatus, a device, and a storage medium. The method includes: showing a target content page to display a multimedia content; determining a content consumption intention on the multimedia content based on browsing information corresponding to the target content page; determining target summary information that adapted to the content consumption intention, where the target summary information is generated at least based on the multimedia content; in response to the content consumption intention being a shallow consumption intention, the target summary information is first summary information; and in response to the content consumption intention being a deep consumption intention, the target summary information is second summary information with a larger information content; and displaying the target summary information on the target content page.

### CROSS-REFERENCE TO RELATED APPLICATION(S)

This application claims priority to Chinese Application No. 202310912603.8 filed Jul. 24, 2023, the disclosure of which is incorporated herein by reference in its entity.

### FIELD

The disclosure relates to the technical field of computers, and in particular to a content processing method and apparatus, a device, and a storage medium.

### BACKGROUND

Currently, in order to cope with the burden of information screening brought to users by the massive growth of information, an information recommendation system often pre-screens some contents that the users may be interested in from the massive information and pushes the contents to the users, and the users acquire required information by browsing these pushed contents. However, the content push method cannot well adapt to information acquisition needs of the users, resulting in low information acquisition efficiency of the users.

### SUMMARY

In order to solve the above technical problems, the disclosure provides a content processing method and apparatus, a device, and a storage medium.

In a first aspect, an embodiment of the disclosure provides a content processing method. The method includes:
showing a target content page to display a multimedia content;
determining a content consumption intention on the multimedia content based on browsing information corresponding to the target content page;
determining target summary information adapted to the content consumption intention, where the target summary information is generated at least based on the multimedia content; in response to the content consumption intention being a shallow consumption intention, the target summary information is first summary information; in response to the content consumption intention is a deep consumption intention, the target summary information is second summary information; and information content of the second summary information is larger than information content of the first summary information; and
displaying the target summary information on the target content page.

In a second aspect, an embodiment of the disclosure further provides a content processing apparatus. The apparatus includes:
a target content page display module, configured to show a target content page to display a multimedia content;
a content consumption intention determining module, configured to determine a content consumption intention on the multimedia content based on browsing information corresponding to the target content page;
a target summary information determining module, configured to determine target summary information adapted to the content consumption intention, where the target summary information is generated at least based on the multimedia content; in response to the content consumption intention being a shallow consumption intention, the target summary information is first summary information; in response to the content consumption intention being a deep consumption intention, the target summary information is second summary information; and information content of the second summary information is larger than information content of the first summary information; and
a target summary information display module, configured to display the target summary information on the target content page.

In a third aspect, an embodiment of the disclosure further provides an electronic device. The electronic device includes:
a processor; and
a memory, configured to store executable instructions,
where the processor is configured to read the executable instructions from the memory, and execute the executable instructions to implement the content processing method described in any embodiment of the disclosure.

In a fourth aspect, an embodiment of the disclosure further provides a computer-readable storage medium, and the storage medium stores a computer program. The computer program, when executed by a processor, enables the processor to implement the content processing method described in any embodiment of the disclosure.

In a fifth aspect, an embodiment of the disclosure further provides a computer program product. The computer program product is configured to perform the content processing method described in any embodiment of the disclosure.

According to the content processing method and apparatus, the device, and the storage medium in the embodiments of the disclosure, the content consumption intention on the multimedia content can be determined based on the browsing information on the target content page displaying the multimedia content, and the target summary information that corresponds to the multimedia content, matches the deep or shallow intention of the content consumption intention, and varies in detail degree is generated, and displayed on the target content page. Accordingly, the user can rapidly acquire the main information mentioned in the required multimedia content through the target summary information matching the information consumption requirements of the user, without completely browsing the multimedia content on the target content page, thereby better satisfying the information acquisition needs of the user and improving information acquisition efficiency of the user so as to enhance user experience.

### BRIEF DESCRIPTION OF THE DRAWINGS

The above and other features, advantages, and aspects of various embodiments of the disclosure will become more apparent in conjunction with the accompanying drawings and with reference to following specific implementations. Throughout the accompanying drawings, same or similar reference numerals denote same or similar elements. It should be understood that the accompanying drawings are illustrative, and components and elements may not necessarily be drawn to scale.

FIG. 1 is a schematic flowchart of a content processing method according to an embodiment of the disclosure;

FIG. 2 is a schematic diagram of a display effect of first summary information corresponding to a shallow consumption intention according to an embodiment of the disclosure;

FIG. 3 is a schematic diagram of a display effect of second summary information corresponding to a deep consumption intention according to an embodiment of the disclosure;

FIG. 4 is a schematic flowchart of another content processing method according to an embodiment of the disclosure;

FIG. 5 is a schematic diagram of a display effect of second summary information and an extended content corresponding to a deep consumption intention according to an embodiment of the disclosure;

FIG. 6 is a schematic diagram of a display effect of second summary information and an extended content corresponding to another deep consumption intention according to an embodiment of the disclosure;

FIG. 7 is a structural schematic diagram of a content processing apparatus according to an embodiment of the disclosure; and

FIG. 8 is a structural schematic diagram of an electronic device according to an embodiment of the disclosure.

### DETAILED DESCRIPTION OF EMBODIMENTS

The embodiments of the disclosure will be described in more detail below with reference to the accompanying drawings. Although the accompanying drawings show some embodiments of the disclosure, it should be understood that the disclosure may be implemented in various forms, and should not be construed as being limited to the embodiments stated herein.

On the contrary, these embodiments are provided for a more thorough and complete understanding of the disclosure. It should be understood that the accompanying drawings and the embodiments of the disclosure are for exemplary purposes only, and are not intended to limit the scope of protection of the disclosure.

It should be understood that the steps recorded in the method implementations in the disclosure may be performed in different orders and/or in parallel. In addition, the method implementations may include additional steps and/or omit the execution of the shown steps. The scope of the disclosure is not limited in this aspect.

The term “including” and variations thereof used in this specification are open-ended, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description.

It should be noted that “first,” “second,” and other concepts mentioned in the disclosure are only for distinguishing different apparatuses, modules, or units, and are not intended to limit the order or relation of interdependence of functions performed by these apparatuses, modules, or units.

It should be noted that modifications of “a” and “a plurality of” mentioned in the disclosure are indicative rather than limiting, and those skilled in the art should understand that unless otherwise explicitly specified in the context, it should be interpreted as “one or more”.

The names of messages or information exchanged between a plurality of apparatuses in the implementations of the disclosure are provided for illustrative purposes only, and are not intended to limit the scope of these messages or information.

An information recommendation system in the related art may pre-screen some information that a user may be interested in from massive information based on an information browsing history of the user and the type of interesting information inputted by the user, and push the information to be user. The user acquires the desired content by browsing the pushed information. However, according to the information pushing method, a consumption degree/interest degree of the user on the pushed information cannot be distinguished, which requires the user to acquire information by browsing the complete information content, resulting in low information acquisition efficiency of the user. Especially, when the pushed information has a low matching degree with an interest point of the user, the user may not want to browse the pushed information, resulting in lower information acquisition efficiency.

Based on the above situation, an embodiment of the disclosure provides a content processing solution, so as to determine, based on a browsing situation of the user on a multimedia content on a target content page, an interest degree (i.e., a content consumption intention) of the user on the multimedia content, and utilize, based on determined different interest degrees (i.e., a shallow consumption intention and a deep consumption intention), the multimedia content to generate target summary information of different detail degrees (respectively corresponding to first summary information and second summary information), and display the target summary information on the target content page for the user to browse. Accordingly, a key content with an appropriate information content can be pushed according to different information acquisition demands of the user for the multimedia content. The user can rapidly acquire the desired information without completely browsing the multimedia content on the target content page, thereby improving the adaptability of the pushed summary to the information acquisition demands of the user, and improving information acquisition efficiency and accuracy of the user so as to enhance user experience.

The content processing method provided by this embodiment of the disclosure is applicable to an information pushing scenario when the user browses webpage information.

The method may be performed by a content processing apparatus. The apparatus may be implemented by software and/or hardware. The apparatus may be integrated into an electronic device with a display function. The electronic device may include, but is not limited to, mobile terminals such as a smart phone, a personal digital assistant (PDA), a tablet personal computer (Tablet PC), a notebook computer, a vehicle-mounted terminal (e.g., a vehicle-mounted navigation terminal), and a wearable device, as well as fixed terminals such as a digital TV, a desktop computer, and a smart home device.

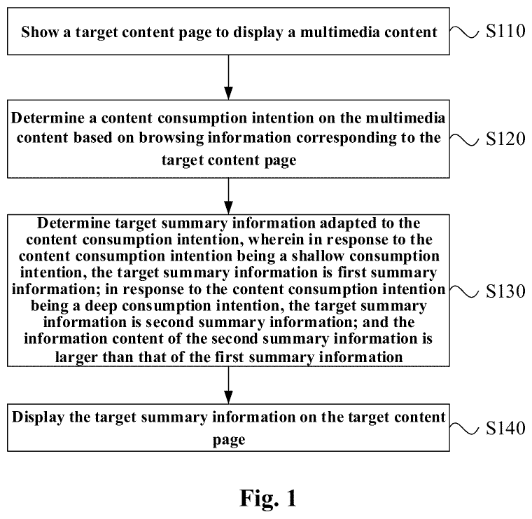

FIG. 1 is a schematic flowchart of a content processing method according to an embodiment of the disclosure. As shown in FIG. 1, the content processing method may include the following steps:

S110: a target content page is shown to display a multimedia content.

The target content page is a page that a current user (also known as a target user) is browsing.

Specifically, an electronic device may respond to an operation of the target user so as to show the target content page. The multimedia content, such as a graphic and text content, and an audio and video content is displayed on the target content page. The target user acquires corresponding content information by browsing the multimedia content.

In an example, the operation of the target user may be a trigger operation on any one of search results on a search result page obtained through a search. The electronic device may jump, in response to the trigger operation, from the search result page to a detail page (or known as a landing page) of a triggered search result, and display the detail page. The detail page is the target content page in the operation scenario.

In another example, the operation of the target user may be a trigger operation on a piece of information pushed on an information stream (also known as a feed stream) page. The electronic device may jump, in response to the trigger operation, from the feed stream page to a detail page of triggered information, and display the detail page. The detail page is the target content page in the operation scenario.

In another example, the operation of the target user may be a trigger operation on hyperlink information. The electronic device may jump, in response to the trigger operation, from an original page to a detail page to which the hyperlink information points, and display the detail page. The detail page is the target content page in the operation scenario.

S120: a content consumption intention on the multimedia content is determined based on browsing information corresponding to the target content page.

The browsing information refers to information acquired in a browsing process and related to a browsing behavior. The content consumption intention is used for representing a content acquiring degree of the target user on the multimedia content, such as a progress of browsing the multimedia content, browsing duration, and a browsing speed. Accordingly, the content consumption intention may include a shallow consumption intention and a deep consumption intention. The shallow consumption intention represents a low degree of multimedia content acquisition by the target user, indicating that the target user may not be interested in the multimedia content. The deep consumption intention represents a high degree of multimedia content acquisition by the target user, indicating that the target user is greatly interested in the multimedia content.

Specifically, the electronic device may collect behavior information of the target user in the process of browsing the target content page to obtain corresponding browsing information. By measuring the browsing information, the content consumption intention of the target user on the multimedia content may be determined. The content consumption intention may reflect the interest degree of the target user on the multimedia content to a certain degree, thereby providing a reference required by the user during subsequent automatic push content generation.

It should be noted that user information (including but not limited to user device information, user personal information, etc.) and data (including but not limited to data for analysis, stored data, displayed data, etc.) involved in the disclosure are all information and data authorized by the user or sufficiently authorized by each side, and related data collection, use and processing need to comply with relevant laws, regulations, and standards of related countries and regions. A corresponding operation entrance is provided for the user to select for authorization or refusal.

In some embodiments, S120 includes: browsing information is determined based on browsing behavior data on the target content page; and a content consumption intention is determined based on a comparison result between the browsing information and a preset browsing threshold.

The preset browsing threshold is a preset critical value for browsing information, which may be empirically set based on dimensions of browsing information and business requirements for corresponding dimensions. Exemplarily, the browsing information includes at least one of dimensions such as a content browsing progress, content browsing duration, and a content browsing speed. For example, if the browsing information is the content browsing progress and the business requirement is to faster push a content that can be displayed in overlay on the target content page to the user, the preset browsing threshold may be set to a preset browsing progress with a smaller value, such as a 50% browsing progress. For another example, if the browsing information is the content browsing speed and the business requirement is the same as above, the preset browsing threshold may be set to a preset browsing speed with a smaller value, such as the browsing speed of 300 ms. For another example, if the browsing information is the content browsing duration and the business requirement is the same as above, the preset browsing threshold may be set to preset browsing duration with a smaller value. For another example, when the browsing information has a plurality of dimensions, values of the corresponding dimensions may be simultaneously set according to the above examples.

Specifically, the electronic device may collect related browsing behavior data of the target user on the target content page according to the dimensions of the browsing information. Then, corresponding browsing information is obtained by analyzing and processing the browsing behavior data. For example, if the collected browsing behavior data includes a moment when the target content page is displayed (or a corresponding moment when the target user starts a swipe operation on the target content page) and a current moment, a difference between the current moment and the above moment may be calculated to obtain the content browsing duration of the target user on the target content page. For another example, if the collected browsing behavior data includes a mouse scrolling speed, a touch swiping speed, or an eye movement speed, the content browsing speed may be obtained based on these data. For another example, when the collected browsing behavior data includes a starting position of the multimedia content on the target content page and a stay position at the current moment, a proportion of a browsed content in the multimedia content can be obtained based on these two positions, which serves as the content browsing progress. It should be noted that the process of obtaining the browsing information through the browsing behavior data may be performed locally on the electronic device. Alternatively, the electronic device may send the browsing behavior data to a server side, and after the server side performs execution, the above browsing information is returned to the electronic device.

Then, the electronic device may compare the browsing information with the preset browsing threshold, and determines a content consumption intention based on a comparison result. For example, a first browsing threshold and a second browsing threshold may be respectively set for the shallow consumption intention and the deep consumption intention. If the browsing information reaches the first browsing threshold, the content consumption intention is determined as the shallow consumption intention; and if the browsing information reaches the second browsing threshold, the content consumption intention is determined as the deep consumption intention. The first browsing threshold and the second browsing threshold may be equal or unequal.

Exemplarily, the above step of determining a content consumption intention based on a comparison result between the browsing information and the preset browsing threshold includes at least one of the following steps A to F.

Step A: the content consumption intention is determined as the shallow consumption intention if the browsing information is the content browsing progress, and the content browsing progress is smaller than the preset browsing progress.

Specifically, if the determined content browsing progress of the target user is smaller than the preset browsing progress, it indicates that the target user only browses a small portion of multimedia content, and the content consumption intention may be determined as the shallow consumption intention, indicating that the target user is less interested in the multimedia content to a certain degree.

Step B: the content consumption intention is determined as the deep consumption intention if the browsing information is the content browsing progress, and the content browsing progress is greater than or equal to the preset browsing progress.

Specifically, if the determined content browsing progress of the target user is greater than or equal to the preset browsing progress, it indicates that the target user browses a large portion of multimedia content, and the content consumption intention may be determined as the deep consumption intention, indicating that the target user is greatly interested in the multimedia content to a certain degree.

Step C: the content consumption intention is determined as the shallow consumption intention if the browsing information is the content browsing duration, and the content browsing duration is smaller than the preset browsing duration.

Specifically, if the determined content browsing duration of the target user is smaller than the preset browsing duration, it indicates that the target user only browses the multimedia content for a short period of time and consumes less multimedia content, and the content consumption intention may be determined as the shallow consumption intention, indicating that the target user is less interested in the multimedia content to a certain degree.

Step D: the content consumption intention is determined as the deep consumption intention if the browsing information is the content browsing duration, and the content browsing duration is greater than or equal to the preset browsing duration.

Specifically, if the determined content browsing duration of the target user is greater than or equal to the preset browsing duration, it indicates that the target user browses the multimedia content for a long period of time and consumes more multimedia content, and the content consumption intention may be determined as the deep consumption intention, indicating that the target user is greatly interested in the multimedia content to a certain degree.

Step E: the content consumption intention is determined as the shallow consumption intention if the browsing information is the content browsing speed, and the content browsing speed is greater than or equal to the preset browsing speed.

Specifically, if the determined content browsing speed of the target user is greater than the preset browsing speed, it indicates that the target user rapidly browses the multimedia content, the amount of information acquired by the user from the multimedia content is limited, and therefore the content consumption intention may be determined as the shallow consumption intention, indicating that the target user is less interested in the multimedia content to a certain degree.

Step F: the content consumption intention is determined as the deep consumption intention if the browsing information is the content browsing speed, and the content browsing speed is less than the preset browsing speed.

Specifically, if the determined content browsing speed of the target user is smaller than the preset browsing speed, it indicates that the target user slowly browses the multimedia content, the amount of information acquired by the user from the multimedia content is large, and therefore the content consumption intention may be determined as the deep consumption intention, indicating that the target user is greatly interested in the multimedia content to a certain degree.

S130: target summary information adapted to the content consumption intention is determined; in response to the content consumption intention being the shallow consumption intention, the target summary information is first summary information; in response to the content consumption intention being the deep consumption intention, the target summary information is second summary information; and the information content of the second summary information is larger than that of the first summary information.

The target summary information is a key/core/main content in the multimedia content to be pushed to the target content page to be displayed in overlay. The target summary information is generated at least based on the multimedia content, and or may be generated based on an extended content (an extended content for short) related to the multimedia content.

Specifically, given that the target user has different consumption degrees on the multimedia content, it reflects different interest degrees of the target user on in multimedia content, and therefore the amount of information required to be acquired by the target user from the multimedia content is also different. For example, in the case of the shallow consumption intention, the target user may not want to acquire more information from the multimedia content, while in the case of the deep consumption intention, the target user is likely to need to acquire more information from the multimedia content. Therefore, in order to make the target user rapidly acquire the content of the possibly required information amount from the multimedia content, in this embodiment of the disclosure, the consumption intentions of the target user on the multimedia content can be distinguished, and for the different consumption intentions, the target summary information different in detail degree is generated for the multimedia content.

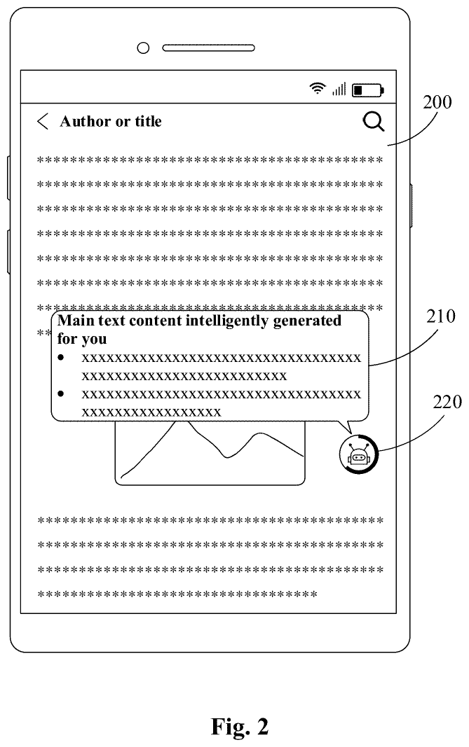

For example, in the case of the shallow consumption intention, the target user is less interested in the multimedia content, and the brief summary information (i.e., the first summary information) may be provided for the target user, such that the target user can more rapidly acquire the main content mentioned in the multimedia content. Referring to FIG. 2, when the electronic device displays a target content page 200 and determines that the target user corresponds to the shallow consumption intention, first summary information 210 which is relatively brief in content length may be displayed on the target content page 200 through a pop-up window.

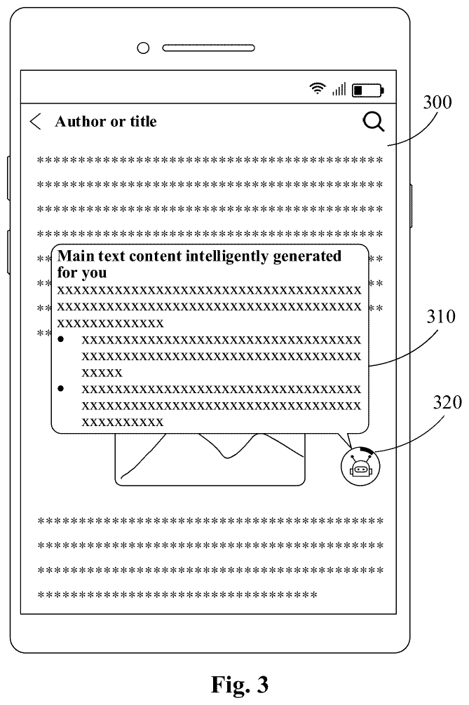

For another example, in the case of the deep consumption intention, the target user is greatly interested in the multimedia content, the detailed summary information (i.e., the second summary information) may be provided for the target user, such that the target user can rapidly and comprehensively acquire the main content mentioned in the multimedia content. Referring to FIG. 3, when the electronic device displays a target content page 300 and determines that the target user corresponds to the deep consumption intention, second summary information 310 which is relatively long in content length may be displayed on the target content page 300 through a pop-up window. It can be seen from FIG. 2 and FIG. 3 that compared to the first summary information, the second summary information 310 not only has more detailed content for each item but also includes an additional summary content.

The above process of generating the target summary information may include: at least inputting the multimedia content and the content consumption intention acquired above into a pre-trained generative model, and outputting and obtaining the target summary information after model operation processing.

It should be noted that the process may be performed locally on the electronic device or on the server side. During execution on the server side, the electronic device may send the multimedia content (or an access address) and the acquired content consumption intention to the server side; and the server side calls the above generative model for processing to obtain the target summary information, and the target summary information is returned to the electronic device. In addition, this embodiment of the disclosure does not limit the generative model and a training process thereof, as long as the function of generating the above target summary information can be achieved.

S140: the target summary information is displayed on the target content page.

Specifically, the electronic device may display the target summary information on the target content page according to a preset display method. The display method may include, for example, at least one of display time, a display position, and a display style. The display time may be, for example, triggered for display in response to an operation of the target user, and/or, may be automatically triggered for display when preset conditions are satisfied. The display position may be a certain fixed position on the target content page (e.g., a page starting position, a page middle position, or a page ending position), a certain fixed position on a display screen (e.g., a bottom area and a middle), or a position where the human eye is focused. The display style may be a style of an information display area, including, for example, a floating window style, a pop-up window style, and a banner control style. The display style may also include a display style of the target summary information, such as highlighting certain text contents in bold or with a brighter style, and distinguishing display of text contents based on different content dimensions.

In some embodiments, S140 includes: displaying a summary guidance control on the target content page; and displaying, in response to a trigger operation on the summary guidance control, the target summary information in a preset area of the target content page.

The summary guidance control is a control configured to guide the target user to perform a corresponding interactive operation so as to trigger the display of the target summary information. For example, the summary guidance control may be a gesture-operated guidance text control, a clickable interactive button control, etc.

Specifically, the electronic device may display the summary guidance control at an appropriate position on the target content page to guide the target user. When the target user performs an operation corresponding to the summary guidance control, for example, the target user performs a corresponding gesture or clicks on the summary guidance control, the electronic device displays, in response to the operation, the target summary information in the preset area of the target content page. The preset area here may be a floating window, a pop-up window, etc., on the target content page, or a preset fixed area within the target content page. When the preset area is the floating window or the pop-up window, the preset area may be fixed to a certain position on the display screen or may slide along with the swiping operation of the target user on the target content page. By setting the summary guidance control, the user can flexibly view or close the target summary information as needed, thereby improving interactive experience of summary push and reality.

In some other embodiments, S140 includes: popping up a display window at a preset position on the target content page and displaying the target summary information within the display window if the browsing information is within a preset browsing range.

The preset browsing range is a preset information range for information browsing, which may be set according to business requirements for automatically displaying the target summary information. For example, when the browsing information is the content browsing progress, the preset browsing range corresponding to the shallow consumption intention may be set to a browsing progress range of 40% to 50%, and the preset browsing range corresponding to the deep consumption intention may be set to a browsing progress range of 90% to 100%. It should be noted that a boundary value in the preset browsing range may be consistent with a preset browsing threshold or unrelated to the preset browsing threshold. The preset position is a preset display position, such as a bottom position of the target content page, a middle position of the display screen, or a position where the human eye is focused.

Specifically, in order not to increase the interactive operations of the target user during the browsing of the target content page so as to reduce the interaction burden of the target user, the electronic device may automatically determine whether to display the target summary information when the target user normally browses the target content page. In this case, the electronic device may compare the browsing information with the preset browsing range in real time or periodically. If the browsing information does not reach the preset browsing range, the target summary information is not automatically displayed, and the electronic device may continue to detect the browsing information. If the browsing information corresponding to the target user reaches the preset browsing range, the display of the target summary information is automatically triggered. A method for implementing the automatic display may be achieved by a pop-up window at a preset position on the target content page and displaying the target summary information within the pop-up window.

Exemplarily, for target summary information with different content consumption intentions, the above process of displaying the target summary information by the pop-up window may include the following steps G and H:

Step G: a display window pops up at a preset position on the target content page if the browsing information is within a first browsing range corresponding to the shallow consumption intention, and first summary information corresponding to the shallow consumption intention is displayed within the display window.

Specifically, referring to the above description of the preset browsing range, the shallow consumption intention may correspond to an independent preset browsing range, namely the first browsing range. Accordingly, when the electronic device determines that the browsing information is within the first browsing range, it may be determined that the first summary information is displayed within the pop-up window. Referring to FIG. 2, when a progress bar in a pop-up window control 220 corresponding to the electronic device triggers the first browsing range, the electronic device displays the first summary information 210 through the pop-up window.

Step H: a display window pops up at a preset position on the target content page if the browsing information is within a second browsing range corresponding to the deep consumption intention, and second summary information corresponding to the deep consumption intention is displayed within the display window, or the second summary information and an extended content related to the multimedia content are displayed within the display window.

Specifically, referring to the above description of the preset browsing range, the deep consumption intention may also correspond to an independent preset browsing range, namely the second browsing range. Accordingly, when the electronic device determines that the browsing information is within the second browsing range, it may be determined that the second summary information is displayed within the pop-up window. Referring to FIG. 3, when a progress bar in a pop-up window control 320 corresponding to the electronic device triggers the second browsing range, the electronic device displays the second summary information 310 through the pop-up window.

It should be understood that when the target user browses the target content page, the shallow consumption intention may be first matched, and as the target user continues to browse the target content page, the deep consumption intention may be matched. Therefore, according to the above solution for automatically displaying the summary information, the browsing information reaching the first browsing range may be first determined, and then the first summary information is automatically displayed to provide the target user with an overview of the main content, assisting the user in determining whether to continue browsing. Then, if it is determined that the browsing information reaches the second browsing range, the second summary information may be automatically displayed to provide the target user with a more detailed main content, assisting the user in learning more content. Accordingly, when the target user browses the page, the target summary information adapted to the current browsing degree of the target user is pushed in real time, thereby further improving adaptability of the pushed content to the consumption degree of the target user on the multimedia content, providing better auxiliary information for the target user to browse the target content page and acquire the content from the target content page, then further improving information acquiring moderation and fluency, and further enhancing user experience.

In some embodiments, after S140, the content processing method further includes: the display window is closed in response to a closing operation on the display window or display duration of the display window reaching preset duration.

Specifically, to reduce interference of the pushed target summary information with the target user in browsing the target content page and improve user interaction convenience, the electronic device may provide a close function control for the popped-up display window or set display duration for the popped-up display window. Then, when the target user triggers the close function control of the display window, or when the display duration of the display window reaches the preset duration, the electronic device may close the pop-up window to hide the target summary information.

According to the content processing method provided in the above embodiments of the disclosure, the content consumption intention on the multimedia content can be determined based on the browsing information on the target content page displaying the multimedia content, and the target summary information that corresponds to the multimedia content, matches the deep or shallow intention of the content consumption intention, and varies in detail degree is generated, and displayed on the target content page. Accordingly, the user can rapidly acquire the main information mentioned in the required multimedia content through the target summary information matching the information consumption requirements of the user, without completely browsing the multimedia content on the target content page, thereby better satisfying the information acquisition needs of the user and improving information acquisition efficiency of the user so as to enhance user experience.

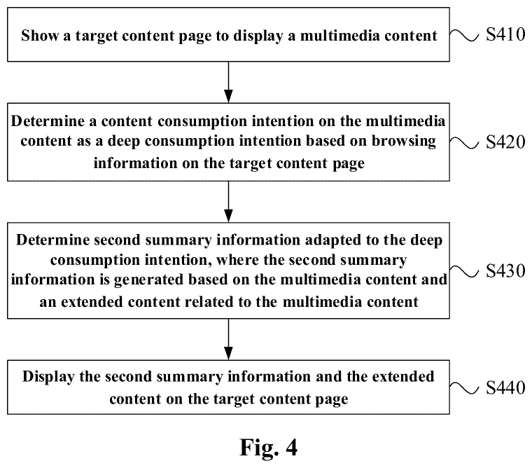

FIG. 4 is a schematic flowchart of another content processing method according to an embodiment of the disclosure. The content processing method includes additional related steps for pushing an extended content for the deep consumption intention based on the content processing method shown in FIG. 1. Referring to FIG. 4, the content processing method includes:

S410: a target content page is shown to display a multimedia content.

S420: a content consumption intention on the multimedia content is determined as a deep consumption intention based on browsing information on the target content page.

S430: second summary information adapted to the deep consumption intention is determined, where the second summary information is generated based on the multimedia content and an extended content related to the multimedia content.

The extended content is acquired based on the multimedia content and is a content that the user may want to further browse.

Specifically, when the content consumption intention reaches the deep consumption intention, it indicates that the target user is greatly interested in the multimedia content, and is likely to further extend consumption regarding the content involved in the multimedia content after browsing the target content page. In the extended consumption process, the target user needs to determine search words for a search operation. This undoubtedly increases the interaction cost and the information screening cost of the user for information acquisition, and also reduces the information acquisition efficiency of the user.

Based on the above situation, when the electronic device determines that the content consumption intention belongs to the deep consumption intention, the extended content related to the multimedia content is obtained. Then, the second summary information is obtained through a generative model, using the multimedia content, the extended content, and the deep consumption intention as input data.

The above extended content acquiring process may be performed locally on the electronic device or on the server side. Given that the extended content is related to the multimedia content, at least some information may be extracted from the multimedia content, and more content (e.g., content in a database) screening and information post-processing (e.g., information extraction and information integration) are performed using the extracted information, thereby obtaining the extended content.

In some embodiments, the extended content is generated by the generative model based on a content type corresponding to the multimedia content and a candidate content; and the content type is determined based on the multimedia content or the second summary information.

Specifically, the electronic device or the server side may first perform information extraction and identification on the multimedia content or the second summary information so as to determine a direction of extended consumption that the target user may be interested, that is, the content type corresponding to the multimedia content is determined, such as a specific entity object or a specific information domain. Then, a content that matches the content type may be selected from a plurality of candidate contents in a content database. Then, the screened content may be directly determined as the extended content; alternatively, the screened content may be first sorted and excerpted to obtain a portion of sorted content as the extended content; and alternatively, the screened content may be utilized for generating a new content, and the newly generated content is determined as the extended content. It should be understood that the above process of generating the extended content based on the content type and the candidate content may be implemented as the generative model. It may be ensured that the obtained extended content is relatively relevant to the multimedia content and meets the information acquisition needs of the user, thereby improving a hit probability of subsequent extended contents and enhancing efficiency of user extended consumption.

S440: the second summary information and the extended content are displayed on the target content page.

The extended content includes a key word tag and/or a webpage content. The key word tag is a text control that has an interaction function and displays a key word.

Specifically, to improve the efficiency of extended consumption of the target user, the extended content may be set as a key word tag and/or at least one webpage content. Therefore, when the electronic device pushes and displays the second summary information on the target content page, the above acquired extended content may be pushed and displayed, such that the target user may directly perform extended consumption through selective interaction.

In some embodiments, the webpage content is screened from the candidate content based on the content type corresponding to the multimedia content. Based on the above description of the extended content, when the extended content includes the webpage content, at least one webpage content may be screened from the plurality of candidate contents using the generative model.

In some embodiments, the key word tag is determined based on the multimedia content and/or the webpage content.

Specifically, the process of acquiring the key word tag by the electronic device or the server side is to determine the key word tag based on the multimedia content and/or the webpage content. Given that the key word tag is an interactive tag for extended consumption of the multimedia content, and the webpage content is related to the multimedia content, possible points of interest for the target user may be represented to a certain degree. Therefore, processing such as key word extraction, screening, and sorting may be performed on the multimedia content and/or the acquired webpage content to obtain the key word tag to be pushed. A matching degree between the key word tag and the information acquisition needs of the user can be improved, thereby increasing the hit probability of the subsequent extended contents and then improving the efficiency of user extended consumption.

In some embodiments, referring to the descriptions of the above embodiments, the electronic device may display the second summary information using the floating window or the pop-up window, and therefore in the corresponding window, the extended content may be displayed at the same time. Therefore, the problem that the target user may miss the extended content due to not browsing the end of the target content page where the extended content is displayed can be solved to a great degree. Accordingly, the user can see the extended content without browsing the end of the page, thereby increasing an exposure rate of the extended content, improving efficiency that the user acquires the extended content and a corresponding content thereof, and further improving the information acquisition efficiency of the user.

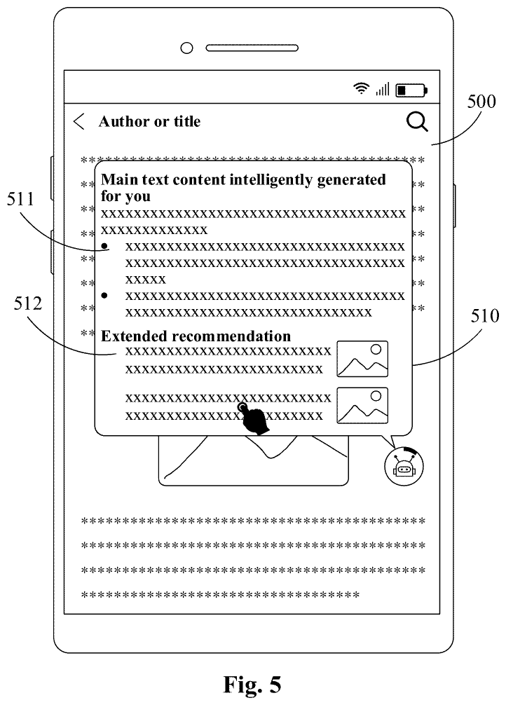

Referring to FIG. 5, the electronic device displays a multimedia content on a target content page 500. As browsing information corresponding to a browsing operation of the target user reaches a second browsing range corresponding to the deep consumption intention, the electronic device may automatically pop up a display window 510, and second summary information 511 and an extended webpage content 512 are displayed in the display window 510.

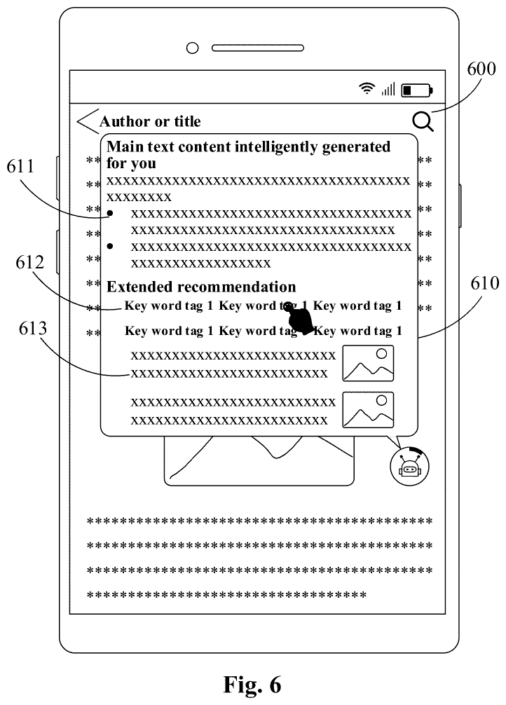

Referring to FIG. 6 again, the electronic device displays a multimedia content on a target content page 600. As browsing information corresponding to a browsing operation of the target user reaches a second browsing range corresponding to the deep consumption intention, the electronic device may automatically pop up a display window 610, and second summary information 611, extended key word tags 612, and an extended webpage content 613 are displayed in the display window 610.

Although not shown in FIG. 5 and FIG. 6, it should be understood that the electronic device may also display the second summary information and the extended key word tags in the display window without displaying the extended webpage content.

In some embodiments, if the extended content is a key word tag, after S440, the content processing method further includes: in response to a trigger operation on a key word tag, a search result page corresponding to the triggered key word tag is displayed.

Specifically, continuing to refer to FIG. 6, when the electronic device displays the key word tags 612, after the target user performs the trigger operation on any one of the key word tags 612, the electronic device may respond to the trigger operation to initiate a research with a key word in the triggered key word tag as a new search word, and display a search result page composed of various search results after the corresponding search results are obtained. A display method for the search result page may be for display through a jump from the target content page to a new page, or for display by creating a floating window on the target content page. This is not limited in embodiments of the disclosure. Accordingly, the target user can more conveniently acquire a search result corresponding to a required key word without determining a search word or performing a search operation, thereby further improving the information acquisition efficiency.

In some other embodiments, if the extended content is a webpage content, after S440, the content processing method further includes: in response to a trigger operation on a webpage content, a content detail page of the webpage content is displayed.

Specifically, continuing to refer to FIG. 5, when the electronic device displays at least one webpage content 512, after the target user performs a trigger operation on any one of the webpage contents 512, the electronic device may acquire, in response to the trigger operation, an access address of the triggered webpage content, and acquires a corresponding detail content by linking the access address. Then, the electronic device may display the content detail page composed of the detail content. A display method for the content detail page may be for display through a jump to a new page, or for display by creating a floating window on the target content page. This is not limited in embodiments of the disclosure. Accordingly, the target user can more conveniently acquire a required webpage content without determining a search word or performing a search operation, thereby further improving the information acquisition efficiency.

According to the content processing method provided in the above embodiments of the disclosure, the second summary information with the more detailed and comprehensive content can be pushed to the target user when the content consumption intention of the target user on the multimedia content is determined as the deep consumption intention, such that the user rapidly acquires more key information from the multimedia content, thereby further improving the information acquisition efficiency and information acquisition comprehensiveness of the user; and in addition, the extended content related to the multimedia content may be additionally pushed to the target user, thereby reducing the operation process of performing related searches by the target user inspired by the multimedia content, reducing an operation path of the user, and saving related cost of post-viewing searches, so as to further improve the information acquisition efficiency of the user.

The following is an embodiment of a content processing apparatus provided by an embodiment of the disclosure. The apparatus and the content processing method in the above embodiments belong to the same inventive concept. For details not fully described in the embodiment of the content processing apparatus, reference may be made to the embodiments of the content processing method.

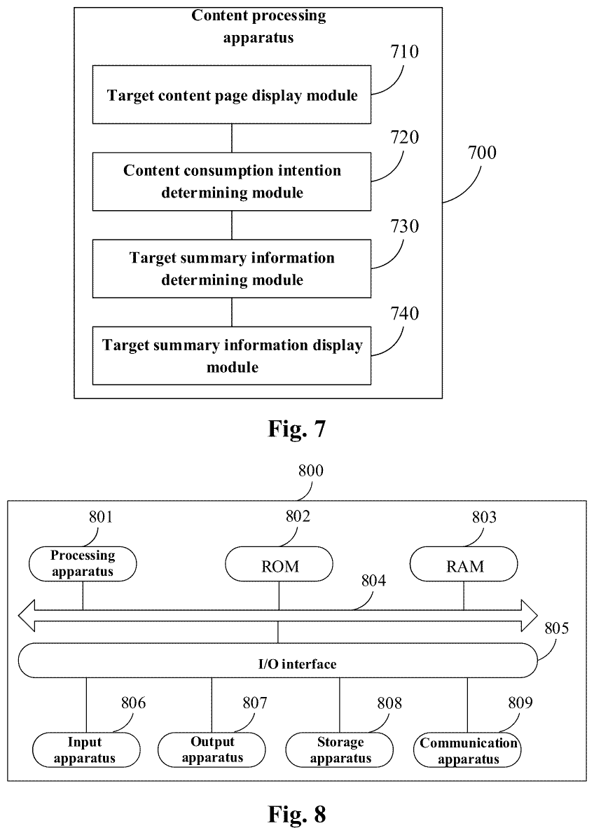

FIG. 7 illustrates a structural schematic diagram of a content processing apparatus according to an embodiment of the disclosure. As shown in FIG. 7, the content processing apparatus 700 may include:
a target content page display module 710, configured to show a target content page to display a multimedia content;
a content consumption intention determining module 720, configured to determine a content consumption intention on the multimedia content based on browsing information corresponding to the target content page;
a target summary information determining module 730, configured to determine target summary information adapted to the content consumption intention, where the target summary information is generated at least based on the multimedia content; n response to the content consumption intention being a shallow consumption intention, the target summary information is first summary information; n response to the content consumption intention being a deep consumption intention, the target summary information is second summary information; and the information content of the second summary information is larger than that of the first summary information; and
a target summary information display module 740, configured to display the target summary information on the target content page.

According to the content processing apparatus provided in the above embodiments of the disclosure, the content consumption intention on the multimedia content can be determined based on the browsing information on the target content page displaying the multimedia content, and the target summary information that corresponds to the multimedia content, matches the deep or shallow intention of the content consumption intention, and varies in detail degree is determined, and displayed on the target content page. Accordingly, the user can rapidly acquire the main information mentioned in the required multimedia content through the target summary information matching the information consumption requirements of the user, without completely browsing the multimedia content on the target content page, thereby better satisfying the information acquisition needs of the user and improving information acquisition efficiency of the user so as to enhance user experience.

In some embodiments, when the content consumption intention is a deep consumption intention, second summary information is generated based on a multimedia content and an extended content related to the multimedia content.

In some embodiments, the extended content is generated by a generative model based on a content type corresponding to the multimedia content and a candidate content; and the content type is determined based on the multimedia content or the second summary information.

In some embodiments, the target summary information display module 740 is specifically configured to:
display the second summary information and the extended content on the target content page, where the extended content includes a key word tag and/or a webpage content.

In some embodiments, the target summary information display module 740 is specifically configured to:

pop up a display window at a preset position on the target content page and display the target summary information within the display window if the browsing information is within a preset browsing range.

Further, the target summary information display module 740 is specifically configured to:
pop up a display window at a preset position on the target content page if the browsing information is within a first browsing range corresponding to the shallow consumption intention, and display the first summary information corresponding to the shallow consumption intention within the display window; and
pop up a display window at a preset position on the target content page if the browsing information is within a second browsing range corresponding to the deep consumption intention, and display the second summary information corresponding to the deep consumption intention within the display window, or display the second summary information and an extended content related to the multimedia content within the display window.

In some embodiments, the content processing apparatus 700 further includes a display window closing module, configured to:
close the display window in response to a closing operation on the display window or
display duration of the display window reaching preset duration after popping up the display window at the preset position on the target content page and displaying the target summary information within the display window if the browsing information is within the preset browsing range.

In some embodiments, the target summary information display module 740 is specifically configured to:
display a summary guidance control on the target content page; and
display, in response to a trigger operation on the summary guidance control, the target summary information in a preset area of the target content page.

In some embodiments, the content processing apparatus further includes a page jumping module, configured to:
after displaying the target summary information and the extended content on the target content page, if the extended content includes the key word tag, display, in response to a trigger operation on a key word tag, a search result page corresponding to the triggered key word tag;
or, after displaying the target summary information and the extended content on the target content page, if the extended content includes the webpage content, display, in response to a trigger operation on a webpage content, a content detail page of the webpage content.

In some embodiments, the content consumption intention determining module 720 is specifically configured to:
determine browsing information based on browsing behavior data on the target content page; and
determine a content consumption intention based on a comparison result between the browsing information and a preset browsing threshold, where the browsing information includes at least one of a content browsing progress, content browsing duration, and a content browsing speed.

Further, the content consumption intention determining module 720 is specifically configured to achieve the function of determining the content consumption intention based on the comparison result between the browsing information and the preset browsing threshold through at least one of the following:
the content consumption intention is determined as the shallow consumption intention if the browsing information is the content browsing progress, and the content browsing progress is smaller than a preset browsing progress;
the content consumption intention is determined as the deep consumption intention if the browsing information is the content browsing progress, and the content browsing progress is greater than or equal to the preset browsing progress;
the content consumption intention is determined as the shallow consumption intention if the browsing information is the content browsing duration, and the content browsing duration is smaller than preset browsing duration;
the content consumption intention is determined as the deep consumption intention if the browsing information is the content browsing duration, and the content browsing duration is greater than or equal to the preset browsing duration;
the content consumption intention is determined as the shallow consumption intention if the browsing information is the content browsing speed, and the content browsing speed is greater than or equal to the preset browsing speed; and
the content consumption intention is determined as the deep consumption intention if the browsing information is the content browsing speed, and the content browsing speed is less than a preset browsing speed.

The content processing apparatus provided by this embodiment of the disclosure can perform the content processing method provided by any embodiment of the disclosure, and has the corresponding functional modules and beneficial effects for performing the method.

It should be noted that the various modules included in the embodiment of the above content processing apparatus are only divided according to functional logics, but are not limited to the above division, as long as the corresponding functions can be achieved; and in addition, the specific names of the functional modules are only for the convenience of distinguishing each other, and do not limit the scope of protection of the disclosure.

An embodiment of the disclosure further provides an electronic device. The electronic device may include a processor and a memory, and the memory may be configured to store executable instructions. The processor may be configured to read the executable instructions from the memory, and execute the executable instructions to implement the content processing method in the above embodiments.

FIG. 8 illustrates a structural schematic diagram of an electronic device according to an embodiment of the disclosure.

As shown in FIG. 8, the electronic device 800 may include a processing apparatus 801 (e.g., a central processing unit and a graphics processing unit), which may perform various appropriate actions and processing according to programs stored on a read-only memory (ROM) 802 or loaded from a storage apparatus 808 into a random access memory (RAM) 803. The RAM 803 further stores various programs and data required for the operation of the electronic device 800. The processing apparatus 801, the ROM 802, and the RAM 803 are connected to one another through a bus 804. An input/output interface (I/O interface) 805 is also connected to the bus 804.

Typically, the following apparatuses may be connected to the I/O interface 805: an input apparatus 806, including, for example, a touchscreen, a touchpad, a keyboard, a mouse, a camera, a microphone, an accelerometer, and a gyroscope; an output apparatus 807, including, for example, a liquid crystal display (LCD), a speaker, and a vibrator; the storage apparatus 808, including, for example, a magnetic tape and a hard drive; and a communication apparatus 809. The communication apparatus 809 may allow the electronic device 800 to be in wireless or wired communication with other devices for data exchange.

It should be noted that the terminal device 800 shown in FIG. 8 is merely an example, which should not impose any limitations on functions and application ranges of the embodiments of the disclosure. That is, although FIG. 8 illustrates the electronic device 800 with various apparatuses, it should be understood that it is not necessary to implement or have all the shown apparatuses. Alternatively, more or fewer apparatuses may be implemented or provided.

Particularly, the foregoing process described with reference to the flowcharts according to the embodiments of the disclosure may be implemented as a computer software program. For example, an embodiment of the disclosure includes a computer program product including a computer program carried on a non-transitory computer-readable medium. The computer program includes program code for performing the method shown in the flowchart. In this embodiment, the computer program may be downloaded and installed from the network through the communication apparatus 809, or installed from the storage apparatus 808, or installed from the ROM 802. The computer program, when executed by the processing apparatus 801, performs the above functions limited in the content processing method in any embodiment of the disclosure.

An embodiment of the disclosure further provides a computer-readable storage medium, storing a computer program. The computer program, when executed by a processor, enables the processor to implement the content processing method in any embodiment of the disclosure.

It should be noted that the computer-readable medium in the disclosure may be a computer-readable signal medium, or a computer-readable storage medium, or any combination of the above. For example, the computer-readable storage medium may include, but is not limited to: electrical, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM or a flash), fiber optics, a portable compact disc read-only memory (CD-ROM), an optical storage device, a magnetic storage device, or any proper combination of the above. In the disclosure, the computer-readable storage medium may be any tangible medium including or storing a program, and the program may be used by an instruction execution system, apparatus, or device, or used in conjunction with the instruction execution system, apparatus, or device. However, in the disclosure, the computer-readable signal medium may include data signals propagated in a baseband or propagated as a part of a carrier wave, which carry computer-readable program code. The propagated data signals may have a plurality of forms, including but not limited to electromagnetic signals, optical signals, or any proper combination of the above. The computer-readable signal medium may also be any computer-readable medium other than the computer-readable storage medium. The computer-readable signal medium may send, propagate, or transmit the program used by the instruction execution system, apparatus, or device, or used in conjunction with the instruction execution system, apparatus, or device. The program code included in the computer-readable medium may be transmitted by any proper medium including but not limited to a wire, an optical cable, radio frequency (RF), etc., or any proper combination of the above.

In some implementations, a client and a server can communicate using any currently known or future-developed network protocols such as a hypertext transfer protocol (HTTP), and may also be in communication connection with digital data in any form or medium (e.g., a communication network). Examples of the communication network include a local area network (“LAN”), a wide area network (“WAN”), Internet work (e.g., Internet), a peer-to-peer network (e.g., an ad hoc peer-to-peer network), and any currently known or future-developed networks.

The computer-readable medium may be included in the above electronic device; and may separately exist without being assembled in the electronic device.

The computer-readable medium carries one or more programs. The one or more programs, when executed by the electronic device, enable the electronic device to perform the steps of the content processing method described in any embodiment of the disclosure.

In the embodiments of the disclosure, computer program code for performing the operations of the disclosure may be written in one or more programming languages or a combination thereof. The programming languages include, but are not limited to, object-oriented programming languages such as Java, Smalltalk, C++, as well as conventional procedural programming languages such as “C” or similar programming languages. The program code may be executed entirely on a user computer, partly on the user computer, as a stand-alone software package, partly on the user computer and partly on a remote computer, or entirely on a remote computer or the server. In the case of involving the remote computer, the remote computer may be connected to the user computer through any type of network, including a local area network (LAN) or a wide area network (WAN), or may be connected to an external computer (e.g., utilizing an Internet service provider for Internet connectivity).

The flowcharts and block diagrams in the accompanying drawings illustrate system architectures, functions, and operations possibly implemented by the system, the method, and the computer program product according to the various embodiments of the disclosure. In this regard, each block in the flowcharts or the block diagrams may represent a module, a program segment, or a portion of code, and the module, the program segment, or the portion of code includes one or more executable instructions for implementing specified logical functions. It should also be noted that in some alternative implementations, functions marked in the blocks may also occur in an order different from that marked in the accompanying drawings. For example, two consecutively-shown blocks may actually be executed in parallel basically, but sometimes may also be executed in a reverse order, which depends on involved functions. It should be further noted that each block in the block diagrams and/or the flowcharts, as well as a combination of the blocks in the block diagrams and/or the flowcharts may be implemented by using a dedicated hardware-based system that executes specified functions or operations, or using a combination of special hardware and computer instructions.

The functions described above in this specification may be at least partially executed by one or more hardware logic components. For example, exemplary hardware logic components that can be used include, but are not limited to, a field-programmable gate array (FPGA), an application specific integrated circuit (ASIC), an application specific standard part (ASSP), a system on chip (SOC), a complex programmable logic device (CPLD), etc.

In the context of the disclosure, a machine-readable medium may be a tangible medium that may contain or store a program, and the program may be used by the instruction execution system, apparatus, or device, or used in conjunction with the instruction execution system, apparatus, or device. The machine-readable medium may be a machine-readable signal medium or a machine-readable storage medium. The machine-readable medium may include, but is not limited to: electronic, magnetic, optical, electromagnetic, infrared, or semiconductor systems, apparatuses, or devices, or any proper combination of the above. More specific examples of the machine-readable storage medium may include: an electrical connection based on one or more wires, a portable computer disk, a hard drive, a random access memory (RAM), a read-only memory (ROM), an erasable programmable read-only memory (EPROM or a flash memory), fiber optics, a portable compact disc read-only memory (CD-ROM), an optical storage device, a magnetic storage device, or any proper combination of the above content.

The above descriptions are merely preferred embodiments of the disclosure and explanations of the applied technical principles. Those skilled in the art should understand that the scope of open in the disclosure is not limited to the technical solutions formed by specific combinations of the above technical features, and also covers other technical solutions formed by arbitrary combinations of the above technical features or equivalent features without departing from the concept of the disclosure, such as a technical solution formed by replacing the above features with the technical features with similar functions disclosed (but not limited to) in the disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the disclosure. Certain features described in the context of separate embodiments may also be implemented in combination in a single embodiment. Conversely, various features described in the context of a single embodiment may also be implemented separately or in any suitable sub-combination in a plurality of embodiments.

Although the subject has been described by adopting language specific to structural features and/or method logical actions, it should be understood that the subject limited in the appended claims is not necessarily limited to the specific features or actions described above. On the contrary, the specific features and actions described above are merely example forms for implementing the claims.

I/We claim:

1. A content processing method, comprising:
showing a target content page to display a multimedia content;
determining a content consumption intention on the multimedia content based on browsing information corresponding to the target content page;
determining target summary information adapted to the content consumption intention, wherein the target summary information is generated at least based on the multimedia content; in response to the content consumption intention being a shallow consumption intention, the target summary information is first summary information; in response to the content consumption intention being a deep consumption intention, the target summary information is second summary information; and information content of the second summary information is larger than information content of the first summary information; and
displaying the target summary information on the target content page.

2. The method according to claim 1, wherein in response to the content consumption intention being the deep consumption intention, the second summary information is generated based on the multimedia content and an extended content related to the multimedia content.

3. The method according to claim 2, wherein the extended content is generated by a generative model based on a content type corresponding to the multimedia content and a candidate content; and the content type is determined based on the multimedia content or the second summary information.

4. The method according to claim 2, wherein displaying the target summary information on the target content page comprises:
displaying the second summary information and the extended content on the target content page, wherein the extended content comprises a key word tag and/or a webpage content.

5. The method according to claim 1, wherein displaying the target summary information on the target content page comprises:
in response to the browsing information being within a preset browsing range, popping up a display window at a preset position on the target content page and displaying the target summary information within the display window.

6. The method according to claim 1, wherein displaying the target summary information on the target content page comprises:
displaying a summary guidance control on the target content page; and
displaying, in response to a trigger operation on the summary guidance control, the target summary information in a preset area of the target content page.

7. The method according to claim 4, wherein the method further comprises, after displaying the target summary information and the extended content on the target content page:
if the extended content includes the key word tag, displaying, in response to a trigger operation on the key word tag, a search result page corresponding to the triggered key word tag;
or, if the extended content includes the webpage content, displaying, in response to a trigger operation on the webpage content, a content detail page of the webpage content.

8. The method according to claim 1, wherein determining the content consumption intention on the multimedia content based on the browsing information corresponding to the target content page comprises:
determining the browsing information based on browsing behavior data on the target content page; and
determining the content consumption intention based on a comparison result between the browsing information and a preset browsing threshold, wherein the browsing information comprises at least one of a content browsing progress, content browsing duration, and a content browsing speed.

9. The method according to claim 8, wherein determining the content consumption intention based on the comparison result between the browsing information and the preset browsing threshold comprises at least one of the following:
determining, in response to the browsing information being the content browsing progress and the content browsing progress being smaller than a preset browsing progress, the content consumption intention as the shallow consumption intention;
determining, in response to the browsing information being the content browsing progress and the content browsing progress being greater than or equal to the preset browsing progress, the content consumption intention as the deep consumption intention;
determining, in response to the browsing information being the content browsing duration and the content browsing duration being smaller than preset browsing duration, the content consumption intention as the shallow consumption intention;
determining, in response to the browsing information being the content browsing duration and the content browsing duration being greater than or equal to the preset browsing duration, the content consumption intention as the deep consumption intention;
determining, in response to the browsing information being the content browsing speed and the content browsing speed being greater than or equal to a preset browsing speed, the content consumption intention as the shallow consumption intention; and
determining, in response to the browsing information being the content browsing speed and the content browsing speed being less than the preset browsing speed, the content consumption intention as the deep consumption intention.

10. An electronic device, comprising:
a processor; and
a memory, configured to store executable instructions,
wherein the processor is configured to read the executable instructions from the memory, and the executable instructions, when executed by the processor, cause the electronic device to:
show a target content page to display a multimedia content;
determine a content consumption intention on the multimedia content based on browsing information corresponding to the target content page;
determine target summary information adapted to the content consumption intention, wherein the target summary information is generated at least based on the multimedia content; in response to the content consumption intention being a shallow consumption intention, the target summary information is first summary information; in response to the content consumption intention being a deep consumption intention, the target summary information is second summary information; and information content of the second summary information is larger than information content of the first summary information; and
display the target summary information on the target content page.

11. The electronic device according to claim 10, wherein in response to the content consumption intention being the deep consumption intention, the second summary information is generated based on the multimedia content and an extended content related to the multimedia content.

12. The electronic device according to claim 11, wherein the extended content is generated by a generative model based on a content type corresponding to the multimedia content and a candidate content; and the content type is determined based on the multimedia content or the second summary information.

13. The electronic device according to claim 11, wherein the executable instructions causing the electronic device to display the target summary information on the target content page further cause the electronic device to:
display the second summary information and the extended content on the target content page, wherein the extended content comprises a key word tag and/or a webpage content.

14. The electronic device according to claim 10, wherein the executable instructions causing the electronic device to display the target summary information on the target content page further cause the electronic device to:
in response to the browsing information being within a preset browsing range, pop up a display window at a preset position on the target content page and display the target summary information within the display window.

15. The electronic device according to claim 10, wherein the executable instructions causing the electronic device to display the target summary information on the target content page further cause the electronic device to:
display a summary guidance control on the target content page; and
display, in response to a trigger operation on the summary guidance control, the target summary information in a preset area of the target content page.

16. The electronic device according to claim 13, wherein the executable instructions further cause the electronic device to, after displaying the target summary information and the extended content on the target content page:
if the extended content includes the key word tag, display, in response to a trigger operation on the key word tag, a search result page corresponding to the triggered key word tag;
or, if the extended content includes the webpage content, display, in response to a trigger operation on the webpage content, a content detail page of the webpage content.

17. The electronic device according to claim 10, wherein the executable instructions causing the electronic device to determine the content consumption intention on the multimedia content based on the browsing information corresponding to the target content page further cause the electronic device to:
determine the browsing information based on browsing behavior data on the target content page; and
determine the content consumption intention based on a comparison result between the browsing information and a preset browsing threshold, wherein the browsing information comprises at least one of a content browsing progress, content browsing duration, and a content browsing speed.

18. The electronic device according to claim 17, wherein the executable instructions causing the electronic device to determine the content consumption intention based on the comparison result between the browsing information and the preset browsing threshold further cause the electronic device to perform at least one of the following:
determine, in response to the browsing information being the content browsing progress and the content browsing progress being smaller than a preset browsing progress, the content consumption intention as the shallow consumption intention;
determine, in response to the browsing information being the content browsing progress and the content browsing progress being greater than or equal to the preset browsing progress, the content consumption intention as the deep consumption intention;
determine, in response to the browsing information being the content browsing duration and the content browsing duration being smaller than preset browsing duration, the content consumption intention as the shallow consumption intention;
determine, in response to the browsing information being the content browsing duration and the content browsing duration being greater than or equal to the preset browsing duration, the content consumption intention as the deep consumption intention;
determine, in response to the browsing information being the content browsing speed and the content browsing speed being greater than or equal to a preset browsing speed, the content consumption intention as the shallow consumption intention; and
determine, in response to the browsing information being the content browsing speed and the content browsing speed being less than the preset browsing speed, the content consumption intention as the deep consumption intention.

19. A non-transitory computer-readable storage medium, the storage medium has a computer program stored thereon which, when executed by a processor, causes the processor to:
show a target content page to display a multimedia content;
determine a content consumption intention on the multimedia content based on browsing information corresponding to the target content page;
determine target summary information adapted to the content consumption intention, wherein the target summary information is generated at least based on the multimedia content; in response to the content consumption intention being a shallow consumption intention, the target summary information is first summary information; in response to the content consumption intention being a deep consumption intention, the target summary information is second summary information; and information content of the second summary information is larger than information content of the first summary information; and
display the target summary information on the target content page.
